(19) United States
(12) Patent Application Publication
(10) Pub. No.: US 2012/0016518 A1
(43) Pub. Date: Jan. 19, 2012

(54) CONSUMER-OPERATED KIOSKS FOR BUYING AND/OR SELLING CONSUMER PRODUCTS AND ASSOCIATED SYSTEMS AND METHODS

(76) Inventors: Ross D. Saario, Seattle, WA (US); Tony W. Joe, Chicago, IL (US)

(21) Appl. No.: 13/183,391

(22) Filed: Jul. 14, 2011

Related U.S. Application Data
(60) Provisional application No. 61/364,360, filed on Jul. 14, 2010.

(51) Int. Cl. G06Q 30/00; G06F 17/00

(52) U.S. Cl. 700/232; 705/27.1; 235/381

(57) ABSTRACT

Consumer-operated kiosks for buyer and/or selling consumer products and associated systems and methods are disclosed herein. In various embodiments, for example, a method for purchasing consumer electronic products includes providing a consumer-operated kiosk that has a card reading device, a user interface, and an inventory of consumer electronic products stored locally within the kiosk. The method can further include displaying the inventory and displaying transaction options to the user. At least one transaction option corresponds to purchasing one of the consumer electronic products in the inventory. The method can continue by receiving a user selection corresponding to purchasing a product from the inventory, and dispensing the first product from an access door.

### CROSS-REFERENCE TO RELATED APPLICATION(S)

This application claims the benefit of pending U.S. Provisional Patent Application No. 61/364,360, filed Jul. 14, 2010, and entitled SYSTEMS AND METHODS FOR SELLING CONSUMER ITEMS, and which is incorporated herein by reference in its entirety.

### TECHNICAL FIELD

The present disclosure relates generally to systems for buying and/or selling consumer products and, more particularly, to consumer-operated kiosk systems for buying and/or selling consumer electronic products.

### BACKGROUND

The average American household owns 24 consumer electronics products. For example, 76% of all households currently own a cell phone and a digital camera, 40% percent own a gaming console, and 32% own a MP3 player. Consumer electronics products, however, tend to evolve very rapidly, and products that are state of the art become seemingly obsolete overnight. As a result, consumers consistently replace and upgrade their consumer electronics.

Unfortunately, however, the consumer is faced with limited options if he or she wishes to recycle or sell a consumer electronics device. There is often little or no monetary incentive to recycle items, and doing so typically requires a special trip to a recycling center. Consumers wishing to resell their used merchandise may have to resort to conventional classified advertising in newspapers or periodicals, online classified advertising (e.g., craigslist), or an online auction (e.g., eBay®). Each of these options requires the seller to go through multiple steps, including listing the item, photographing the item, uploading the photographs on to a website, and providing a written description of the item and terms of sale. The seller must then be on hand to answer questions from prospective buyers/bidders; and if the item is ultimately sold, the seller must collect from the buyer and package and ship the item.

On the other hand, consumers wishing to buy consumer electronic products may not be inclined to travel to an electronic store to make the purchase, resulting in lost profits for the retailer. Consumers are also more likely to buy electronic products spur of the moment when intrigued by a new device or model. Additionally, with the ever-decreasing size of electronics, consumers are more likely to lose and forget electronics (e.g., cameras, cell phones, flash drives). However, the additional trip to the electronics store to replace the lost item can be inconvenient or impractical, such as after leaving home for a trip. Moreover, there are limited practical venues for purchasing used or refurbished consumer products. Accordingly, the various options for buying and selling consumer items in person-to-person transactions can be burdensome. Therefore, it would be advantageous to provide consumers with a relatively easy way to buy and sell new and used consumer electronics and other items.

### BRIEF DESCRIPTION OF THE DRAWINGS

FIG. 1 is a front view of a consumer-operated kiosk configured in accordance with an embodiment of the disclosure.

FIG. 2A is a flow diagram of a routine for selling an item with the consumer-operated kiosk of FIG. 1 in accordance with an embodiment of the disclosure, and FIG. 2B is a flow diagram of a routine for buying an item with the consumer-operated kiosk of FIG. 1 in accordance with another embodiment of the disclosure.

FIGS. 3A and 3B illustrate display pages for initiating use of the consumer-operated kiosk of FIG. 1 in accordance with an embodiment of the disclosure.

FIGS. 4A and 4B illustrate display pages for selecting a product from the consumer-operated kiosk of FIG. 1 in accordance with an embodiment of the disclosure.

FIGS. 5A and 5B illustrate display pages for providing information about a selected product in the consumer-operated kiosk of FIG. 1 in accordance with an embodiment of the disclosure.

FIGS. 6A and 6B illustrate display pages for providing information about a purchase from the consumer-operated kiosk of FIG. 1 in accordance with an embodiment of the disclosure.

FIGS. 7A and 7B illustrate additional display pages for providing information about a purchase from the consumer-operated kiosk of FIG. 1 in accordance with another embodiment of the disclosure.

FIGS. 8A and 8B illustrate display pages for eliciting feedback about a purchase from the consumer-operated kiosk of FIG. 1 in accordance with an embodiment of the disclosure.

FIG. 9 is a partially schematic isometric view illustrating various components and subsystems associated with the consumer-operated kiosk of FIG. 1 in accordance with an embodiment of the disclosure.

FIG. 10 illustrates a suitable network environment for implementing various aspects of consumer-operated kiosk selling systems configured in accordance with the disclosure.

FIG. 11 is a front isometric view of a consumer-operated kiosk configured in accordance with another embodiment of the disclosure.

FIG. 12 is a front view of a consumer-operated kiosk configured in accordance with yet another embodiment of the disclosure.

FIG. 13A is a flow diagram of a routine for selling an item, and FIG. 13B is a flow diagram of a routine for buying an item with embodiments of consumer-operated kiosks configured accordance with the disclosure.

FIG. 14 is a front isometric view of a consumer-operated kiosk configured in accordance with a further embodiment of the disclosure.

FIG. 15 is a side isometric view of a consumer-operated kiosk configured in accordance with an additional embodiment of the disclosure.

### DETAILED DESCRIPTION

The present disclosure describes various embodiments of consumer-operated kiosks for buying and/or selling consumer items and associated systems and methods. In one embodiment, for example, a system for buying and/or selling consumer products includes a consumer-operated kiosk positioned in a publicly accessible area of a store or other retail location. The kiosk can include a locally stored inventory of new, pre-owned, and/or refurbished consumer electronic products. The kiosk can display a wide variety of new, refurbished, or used items and provide shoppers with product information, such as make, model, age, price, seller reputation/reviews, product pictures, etc. When a buyer wishes to purchase an item, the buyer selects the item, and the machine collects payment, retrieves the item, from the inventory, and dispenses the item. Accordingly, the kiosk can provide an efficient mechanism for buying new and refurbished electronics.

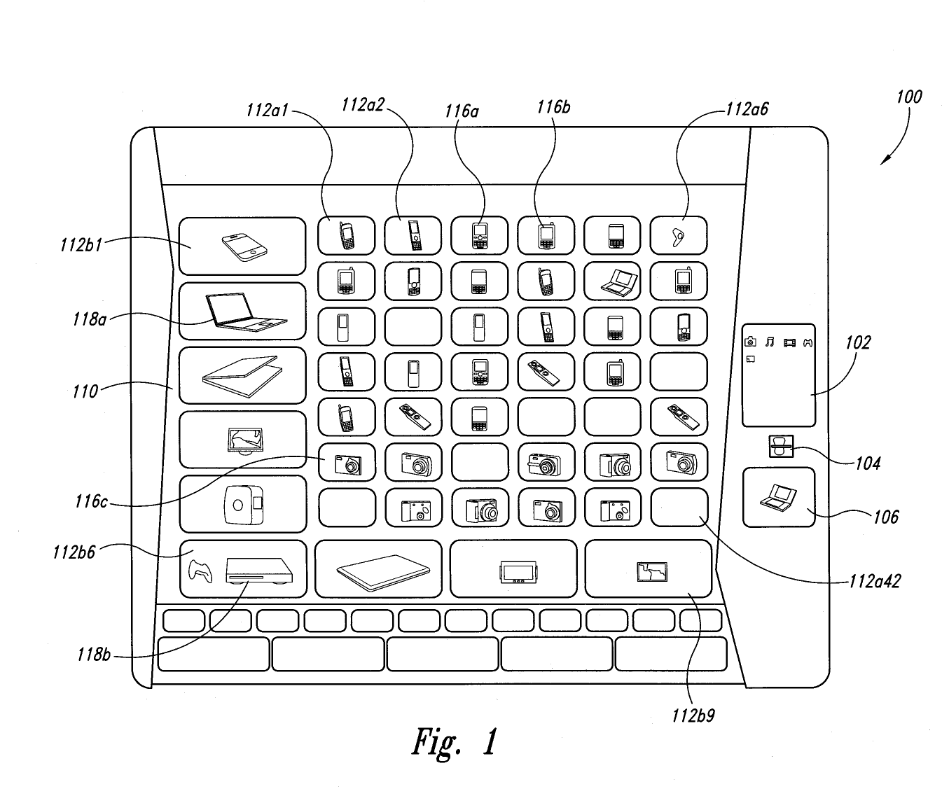

Certain details are set forth in the following description and in FIGS. 1-15 to provide a thorough understanding of various embodiments of the disclosure. Other details describing well-known structures and systems often associated with consumer-operated kiosks and related commerce systems have not been set forth in the following disclosure to avoid unnecessarily obscuring the description of the various embodiments of the invention.

Many of the details, dimensions, functions and other features shown and described in conjunction with the Figures are merely illustrative of particular embodiments of the disclosure. Accordingly, other embodiments can have other details, dimensions, functions and features without departing from the spirit or scope of the present invention. In addition, those of ordinary skill in the art will appreciate that further embodiments of the invention can be practiced without several of the details described below.

FIG. 1 is a front elevation view of a consumer-operated kiosk 100 (“kiosk 100”) configured in accordance with an embodiment of the disclosure. In the illustrated embodiment, the kiosk 100 includes a plurality of first display windows 112a1-112a42 and a plurality of second display windows 112b1-112b9. Each of the display windows 112 is associated with an individual compartment or shelf space having favorable lighting (e.g., internal LED lighting) and positioning to appeal to prospective buyers of items on display. The first windows 112a are relatively smaller than the second windows 112b, and can be used to display smaller handheld or mobile electronics products including, for example, cell phones 116a, personal digital assistants (PDAs) 116b, digital cameras 116c, etc. The larger second windows 112b can be used for displaying laptop computers 118a, game consoles 118b, and/or other relatively large consumer electronics products. Although the illustrated embodiment shows consumer electronics products on display in the kiosk 100, in other embodiments, other types of products and items can be sold from the kiosk 100 including, for example, digital media such as DVDs, videos, games, etc. The kiosk 100 is sufficiently commodious to hold a wide variety of different items. In various embodiments, for example, the kiosk 100 can have a height of approximately five feet to approximately seven feet, and a width of approximately five feet to approximately nine feet. In other embodiments, the kiosk 100 can have other dimensions and shapes without departing from the present disclosure.

In addition to the various display windows 112, the kiosk 100 can further include a user interface 102 and an access door 106. The user interface 102 can include a visual display (e.g., a display screen, monitor, CRT display, touch screen, etc.), and a touch pad, keyboard, touch screen, curser, mouse, and/or other type of user input device that enables users to enter or review product information, purchase an item, input feedback, etc. The access door 106 can provide means for sellers to place items in the kiosk 100 for display. As described in detail below, once items are placed in the access door 106, a robotic or similar system can move the items to pre-assigned display windows 112 for viewing. The access door 106 can also be used to dispense selected items from the kiosk 100 to a buyer. In addition to the foregoing features, the kiosk 100 further includes a card reader 104 for reading account numbers, cardholder information, and/or other types of digital information from magnetic stripes, microchips, optical media, and/or other types of storage media on credit cards, debit cards, and/or other types of financial instruments submitted by users. In other embodiments, the kiosk 100 can include additional mechanisms for receiving payment including, for example, a bill collector and a coin drop.

In one embodiment, the kiosk 100 can be positioned in a publicly accessible area of a retail location, such as a grocery store or home improvement store, and can provide consumers with a means for selling, recycling or otherwise disposing of used or unwanted items, such as consumer electronics products. For example, in one embodiment a user wishing to sell a consumer electronics product can place the product in the kiosk 100 and pay a fee to occupy a “storefront” (i.e., one of the display windows 112) for a selected period of time (e.g., five days). If the product does not sell within the selected period of time, the user can elect to retrieve the product from the kiosk 100, recycle the product, or continue trying to sell the product from the kiosk 100 and, optionally, set a new sales price. The various structures and functions associated with the various kiosk features described above are described in greater detail below.

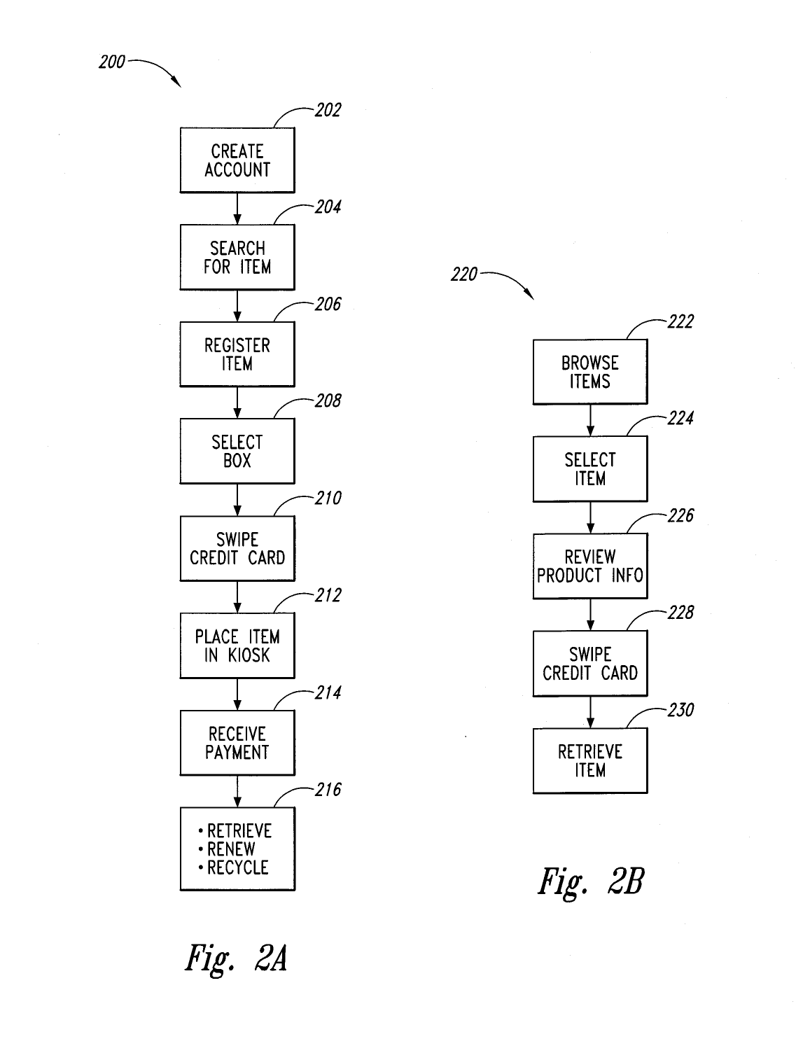

FIG. 2A is a flow diagram of a routine 200 for selling an item with the kiosk 100 in accordance with an embodiment of the disclosure, and FIG. 2B is a flow diagram of a routine 220 for purchasing an item from the kiosk 100 in accordance with another embodiment of the disclosure. Referring first to FIG. 2A, a user wishing to sell an item begins in block 202 and creates an account. This step can include inputting the user's name, mailing address, e-mail address, password, and/or other personal information via the user interface 102, and/or entering credit card or other account information via the card reader 104 (FIG. 1). In block 204, the user searches for the category or type of item they wish to sell. This can include scanning information displayed on the user interface 102 and selecting a desired category, product, version, and/or other information to identify the product. Once the user has identified the type of product for sale, the user registers the item in block 206. This step can include entering product information including, for example, the condition of the product, the desired price, and the method of reimbursement for the sale of the product (e.g., check, credit, PayPal™, etc.). In block 208, the user selects an empty window 112 or “storefront” in which to display the item. This step can include the user affirmatively selecting one of the available windows 112 as displayed on the user interface 102, or the kiosk 100 automatically assigning an appropriate window 112.

In block 210, the user swipes a credit card via the card reader 104 to associate the card information with the particular item for sale. In block 212, the user places the item in the kiosk 100 via the access door 106. As described in greater detail below, the kiosk 100 can include a camera proximate the door 106 to automatically photograph the item before the item is positioned in the selected display window 112. The photograph can then be used to show prospective buyers the actual product via the user interface 102. The photograph can be stored and used and, if necessary, used to verify the item that was sold by the seller and/or form an inventory of the seller's previous sales. The photograph can also be downloaded from a website by remote devices (e.g., computers, smart phones, tablets, etc.) for viewing by potential buyers. Once the user has placed the item in the kiosk 100, potential buyers can view the item, obtain information about the item (via, for example, the user interface 102), and/or purchase the item.

Once the item is sold from the kiosk 100, the seller receives payment in block 214. As described in greater detail below, the seller can be remotely notified of payment via e-mail or other contact information input into the user's account, and the payment can be automatically deposited in the user's account. If the item does not sell at the desired price, the user can elect to retrieve the item from the kiosk 100 in block 216. Alternatively, the user can elect to continue trying to sell the item, or the user can elect to dispose of the item by recycling it via the kiosk 100.

Turning next to FIG. 2B, a user wishing to buy an item from the kiosk 100 begins in block 222 by viewing the items on display. The user can request information about the item via the user interface 102. In block 226, the user reviews the information about the item on the user interface 102. The information can include, for example, item description, condition, various pictures of the item from different perspectives, seller reputation/feedback, and various product reviews. To purchase the item, the user inputs a credit card in block 228 via the card reader 104. After verifying the credit card information and obtaining approval for the purchase, the kiosk 100 retrieves the selected item from the corresponding window 112 and dispenses the item to the user via the access door 106 in block 230. As described in greater detail below, the item can be provided to the user by means of a robotic arm or other mechanism that transfers the item from the associated window 112 to the access door 106.

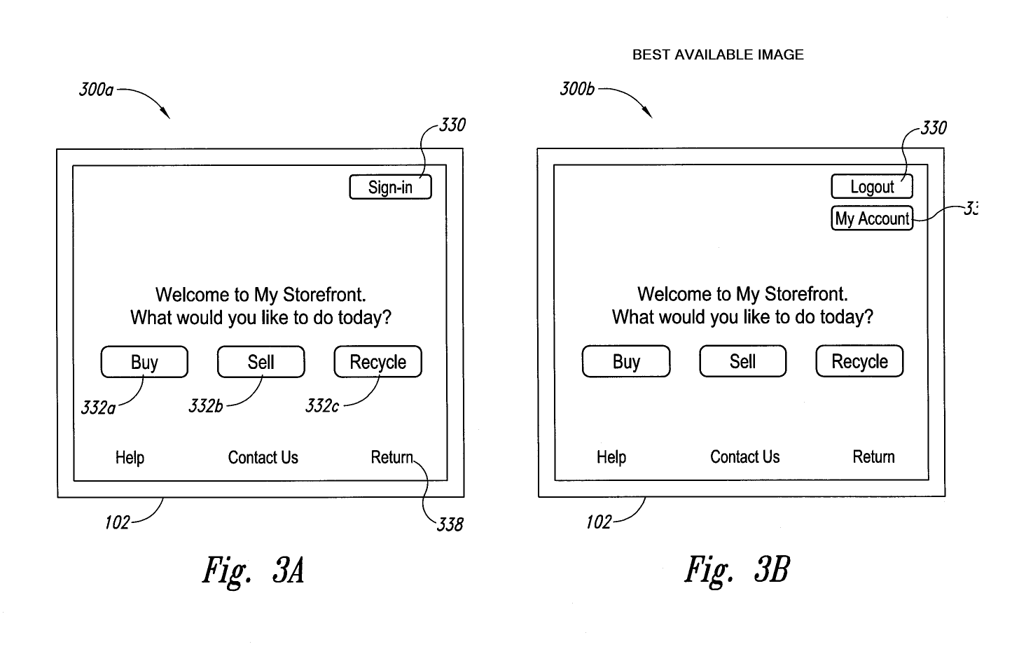

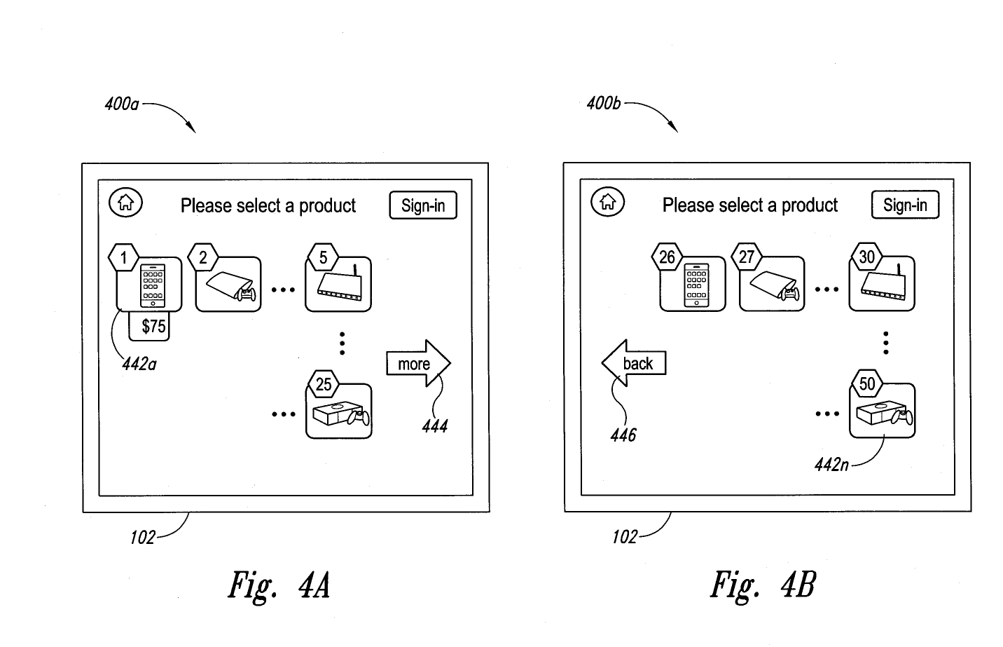

The kiosk 100 operationally interfaces with users via signals, textual instructions, animations, dialogue boxes, selector buttons, icons, and/or other features provided to the user via the user interface 102. FIGS. 3A and 3B, for example, illustrate respective welcome pages 300a and 300b that can be displayed on the user interface screen for initiating a transaction with the kiosk 100. Referring first to FIG. 3A, the display page 300a can include a “Sign-in” selector or button 330 as well as a “Buy” button 332a, a “Sell” button 332b, and a “Recycle” button 332c. If the user has previously created an account, the user can select the “Sign-in” button 330 and provide, on a separate page, a user name and password to identify himself or herself to the kiosk 100. A return user welcome page 300b can then be displayed via the user interface 102. The return user welcome page 300b includes a “Logout” button 336 as well as a “My Account” button 334, in addition to the “Buy” button 332a, the “Sell” button 332b and the “Recycle” button 332c. The “Logout” button 336 allows the user to logout at any time, and the “My Account” button 334 allows the user to access his or her account information. Selecting the “Buy” button 332a initiates the routine for buying a product described in more detail below with reference to FIGS. 4A-7B.

FIGS. 4A and 4B are display pages that can graphically illustrate the different products for sale in the kiosk 100. Each product can be associated with a particular window number, and can include additional information including, for example, the price of the product. A “More” arrow 444 and a “Back” arrow 446 allows the user to toggle between display pages if more than one display page is required to fully illustrate all the products or all the products of a particular type for sale in the kiosk 100 at a particular time. In one aspect of this embodiment, after the user selects a desired product, the selected product is highlighted on the display page 400a or 400b. I In addition, a light (e.g., an LED) inside the associated window 112 can be turned on to illuminate the item and guide the user to the selected product.

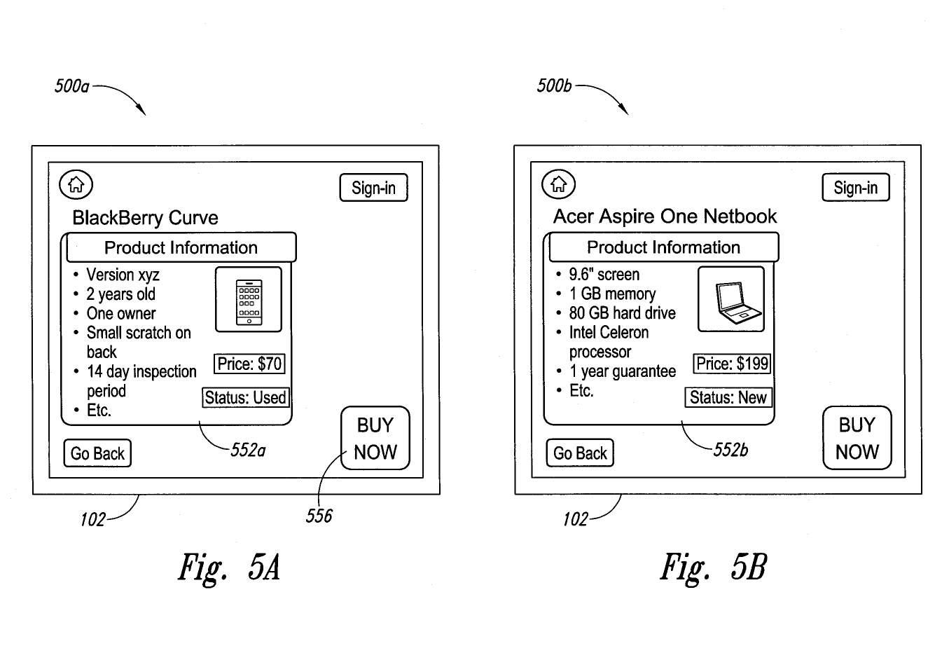

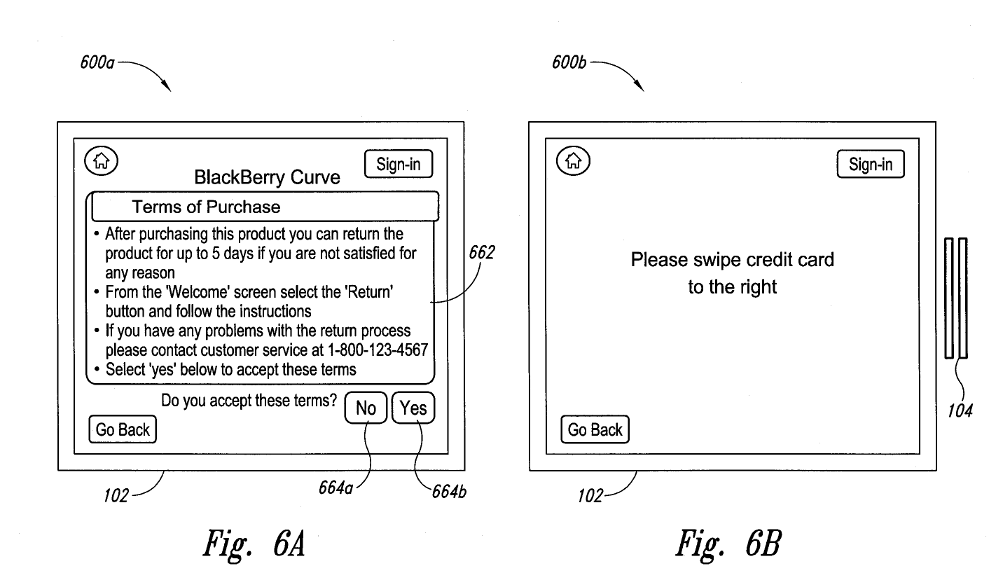

FIGS. 5A and 5B illustrate display pages 500a and 500b, respectively, that included information about the selected product. Each of the display pages 500 includes a corresponding display field 552a, b that provides various information about a selected product. This information can include, for example, the version of the selected product, age, number of owners, condition, whether or not there is a guarantee by the seller or warranty from the manufacturer, performance, specifications, price, etc. The display page 500a shown in FIG. 5A provides information about a used product. As discussed above, however, the kiosk 100 can also be used to sell new or refurbished products. The display page 500b shown in FIG. 5B, for example, provides product information regarding a new notebook computer. In addition to the foregoing features, the display pages 500 can also include a “Go Back” button 554 as well as a “Buy Now” button 556. Selecting the “Buy Now” button 556 can bring up one or more display pages for completing a purchase transaction, as described in more detail below with reference to FIGS. 6A and 6B.

Referring to FIG. 6A, the display page 600a includes a display field 662 that explains terms of purchase for the user. In the illustrated embodiment, the terms allow the user to return the product for up to five days if the user is not satisfied with the product for any reason. To return an item, the user selects a “Return Button” 338 on the welcome page 300a of FIG. 3A. If the user does not accept the terms of purchase, the user can select a “No” button 664a that returns the user to the welcome page 300a. Conversely, if the user does accept the terms of purchase, the user selects a “Yes” button 664b, which brings forth a display page 600b as illustrated in FIG. 6B. The display page 600b instructs the user to swipe his or her credit card through the card reader 104 to pay for the selected item. In other embodiments, the user can pay for the selected item using other suitable payment methods such as cash.

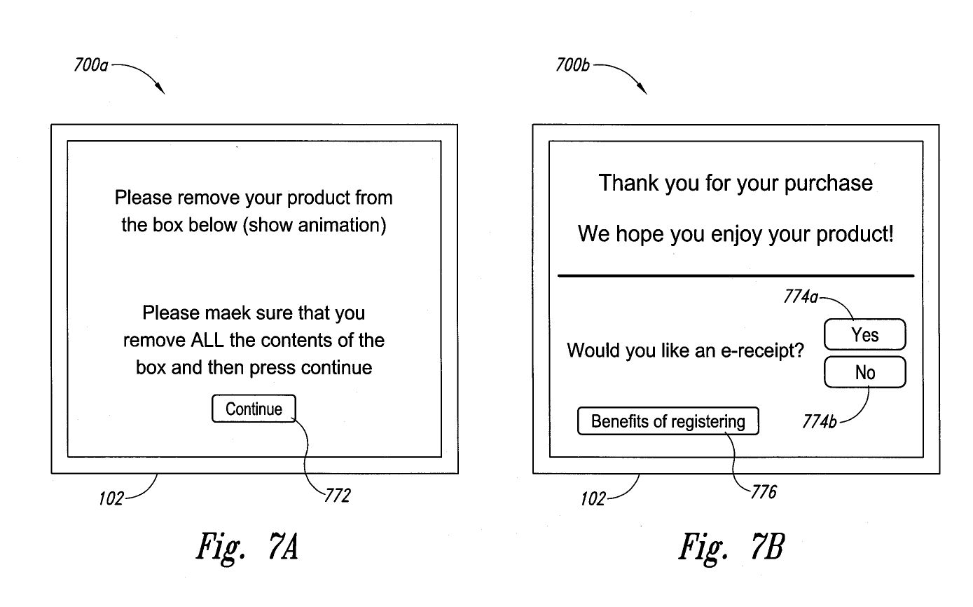

FIGS. 7A and 7B illustrate display pages 700a and 700b, respectively, for concluding a purchase of an item from the kiosk 100. In display page 700a, the user is directed to remove the purchased product from the access door 106. In addition, an animation can be provided that illustrates where the door is located and how to remove product(s). After removing the purchased product, the user can select a “Continue” button 772 to bring up the display page 700b. The user can select a “Yes” button 774a to have an electronic “e-receipt” emailed to the user. Alternatively, the user can select a “No” button 774b to decline the electronic “e-receipt” and/or have the kiosk 100 print a paper receipt. In the illustrated embodiment, the user can also select a “Benefits” button 776 to learn more about the benefits of registering with the kiosk 100.

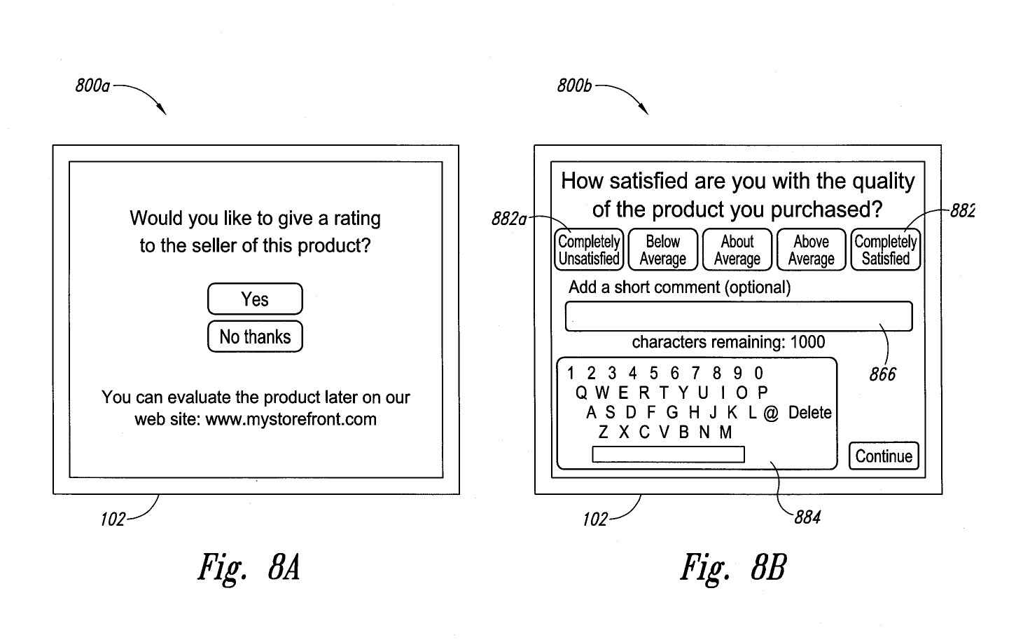

FIGS. 8A and 8B illustrate display pages 800a and 800b, respectively, with which a user can provide feedback about a particular purchase. For example, the user can elect or decline to give a rating to the seller of the purchased product via the display page 800a. The user can provide a rating using the display page 800b shown in FIG. 8B. This display page 800b can include a range of buttons 882a-882e with which the user can express the level of satisfaction with the purchased product. Additionally, the user can optionally include a short comment about the product in field 886 using a keyboard graphic 884 and/or other user input device.

In one aspect of this embodiment, the rating information is sent to the seller via e-mail and stored in the seller's account information. The email can contain a summary of the buyer's evaluation of the purchased item. In another aspect, if a seller receives more than a predetermined number of “completely unsatisfied” buyer rankings, (e.g., two or more such ratings) the seller may be precluded from selling from the kiosk 100 or any kiosk connected thereto in the future.

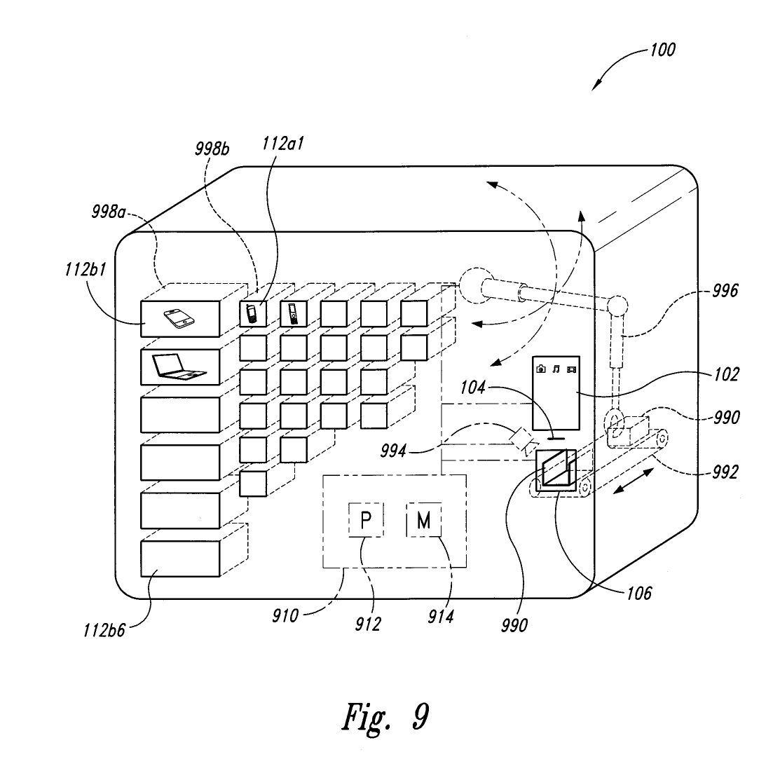

FIG. 9 is a partially schematic isometric view illustrating various structures and subsystems associated with the kiosk 100 of FIG. 1 and configured in accordance with an embodiment of the disclosure. As described above with reference to FIG. 1, the kiosk 100 includes a plurality of smaller windows 112a and larger windows 112b for accommodating differently sized items, such as consumer electronics products. In a further aspect of this embodiment, the kiosk 100 can also include a machine controller 910 having a processor 912 that executes computer readable instructions stored on memory 914 to implement the various display, buy, sell, and other functions of the kiosk 100 described above. The controller 910 can be operably connected to the user interface 102, the card reader 104, the access door 106, a digital camera 994, a robotic arm 996, and lighting controls associated with each of the windows 112. As described in greater detail below, the controller 910 can also include a communications facility (e.g., a router, modem, etc.) for remotely exchanging information with various user computers, servers, financial institutions, and/or other remote computer systems for performing the various notification and transaction functions performed by the kiosk 100.

As described above with reference to FIGS. 1-8B, a user wishing to sell an item via the kiosk 100 can receive associated instructions displayed on the user interface 102. After the user registers or signs into his or her account, the access door 106 can open and the user can position the sale item (e.g., a cell phone, digital camera, etc.) in a display tray or box 990 supported by a conveyor 992. When the access door 106 closes, the camera 994 can automatically photograph the sale item and store the photograph in the memory 914. The conveyor 992 can then move the display box 990 into the kiosk 100 where a set of claws and/or other suitable grasping mechanism on a distal end of the robotic arm 996 picks up the display box 990 and positions it in the selected window 112 for display. The robotic arm 996 can include various linkages, pivoting joints, and/or telescoping members as required to move the display box 990 from the conveyor 992 into one of the window 112. When another user wishes to sell an item, the robotic arm 996 places a second display box 990 on the conveyor 992 for receiving the second user's item.

When a buyer selects an item from one of the windows 112, the robotic arm 996 can retrieve the associated display box 990 from the window 112 and position it on the conveyor 992 for delivery to the access door 106. Although FIG. 9 illustrates one system and method for moving sale items within the kiosk 100, those of ordinary skill in the art will readily appreciate that various other systems and devices can be used to place and remove items from the windows 112 without departing from the spirit or scope of the present disclosure.

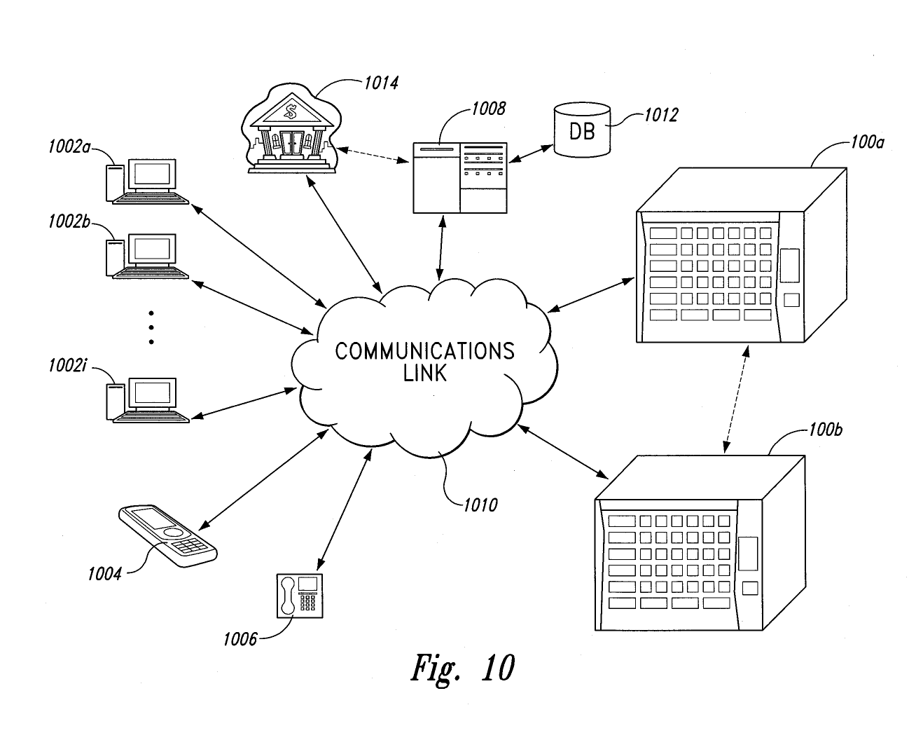

FIG. 10 illustrates a suitable system or network environment for implementing various aspects of the commerce system described in detail above. In the illustrated embodiment, a plurality of the kiosks 100 are operatively connected to a plurality of user computers 1002 (e.g., personal computers in homes, businesses, etc.) via the Internet, a dedicated network, and/or other communications link 1010. Each user computer 1002 can include one or more processors coupled to one or more user input devices and data storage devices. The user computers 1002 can also be coupled to at least one output device such as a display device and one or more optional additional output devices (e.g., printer, plotter, speakers, tactile or olfactory output devices, etc.). The computer may be coupled to external computers, such as via an optional network connection, a wireless transceiver, or both.

The kiosks 100 can also be operably coupled to various handheld communications devices, such as a PDA or cell phone 1004 and/or a landline or conventional telephone 1006, via the communications link 1010. Moreover, the kiosks 100 can also be operably connected to a remote server computer 1008 that can retrieve display pages (e.g., the display pages described above with respect to FIGS. 3A-8B) and/or data from a database 1012 for implementing the various transactions described above. In other embodiments, all or a portion of the display pages can be locally stored in a local memory in the kiosk 100. The server 1008 and/or an associated host computer (not shown) can communicate with a financial institution 1014 to conduct credit card purchases, transfer funds between accounts, etc.

The server computer 1008 performs much or all of the functions for receiving, routing and storing of electronic messages (e.g., web pages), audio signals (e.g., vocal audio), and electronic images (e.g., animation images) to the kiosks 100 and other devices connected to the communications link 1010. A database 1012 coupled to the server computer 1008 stores much of the web pages and content exchanged between the user computers 1002 and/or the kiosks 100. The server computer 1008, including the database 1012, may employ security measures to inhibit malicious attacks on the system and to preserve integrity of the messages and data stored therein (e.g., firewall systems, secure socket layers (SSL) password protection schemes, encryption, etc.).

The server computer 1008 can include a server engine, a web page management component, a content management component and a database management component. The server engine performs basic processing and operating system level tasks. The web page management component handles creation and display or routing of web pages. Users may access the server computer 1008 by means of a URL associated therewith. The content management component handles most of the functions in the embodiments described herein. The database management component includes storage and retrieval tasks with respect to the database 1012, queries to the database 1012, and storage of data such as animation graphics and audio signals.

One skilled in the relevant art will appreciate that the concepts of the invention can be used in various environments other than location based or the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the invention described herein can be implemented in or for any e-mail environment.

In various aspects of the illustrated embodiment, operably connecting the kiosks 100 to the Internet or other communication link 1010 enables the kiosks 100 to conduct credit card transactions, exchange information (e.g., status information) with a remote operator or service location, and communicate with both buyers and sellers. For example, in one embodiment, the network can enable sellers to log onto a kiosk website and check the status of a sale (e.g., how many times the item has been viewed), change the sale price, cancel the sale, etc. In addition, the network can also enable potential buyers to view items for sale via a user computer 1002 from a convenient location. For example, a user using one of the user computers 1002 can request a web page from the server 1008 illustrating available products for sale via one or more of the kiosks 100. If the user views a product of interest, the user can determine the location of the kiosk 100 that contains the product. The user can either place an item on hold or purchase the item via their user computer, and then proceed to the particular kiosk 100 to retrieve the product. Alternatively, sellers of products can use their user computers 1002 to determine if the product has been sold. Additionally, a user wishing to purchase a particular type of product (e.g., a certain make of cell phone) from one or more kiosks 100 can identify the type product on a website associated with the kiosks 100, and then ask to receive text messages or other electronic alerts via e-mail, cell phone 904, conventional telephone 906, if or when the product becomes available at one of the kiosks 100. Accordingly, the foregoing illustrate only some of the ways that the kiosks 100 described above can be employed to sell new products, resell refurbished or used products, and/or recycle products.

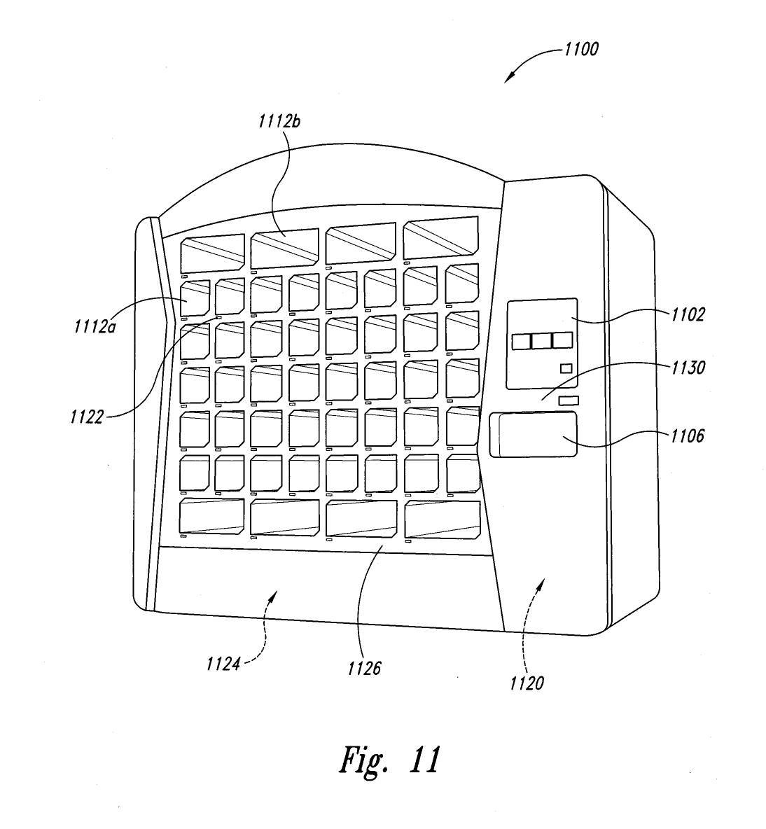

FIG. 11 is a front isometric view of a consumer-operated kiosk 1100 (“kiosk 1100”) configured in accordance with another embodiment of the disclosure. Many features and aspects of the kiosk 1100 are at least generally similar in structure and function to the kiosk 100 described in detail above. For example, the kiosk 1100 includes a plurality of first display windows 1112a, a plurality of relatively larger, second display windows 1112b, a user interface 1102, and an access door 1106. In one aspect of this particular embodiment, however, the kiosk 1100 further includes a plurality of individual price displays (e.g., LED price displays) 1122 associated with the different items in each of the display windows 1112. The prices in the price displays 1122 can be updated when a new product is displayed, and if the seller subsequently changes the price of a product via the user interface 1102, or remotely via the Internet, a handheld device, or a telephone.

In another aspect of this embodiment, the kiosk 1100 also includes a removable façade or “wallpaper” that can be easily removed and replaced to change the appearance of the kiosk 1100 and/or display co-branding or advertising proximate the display windows 1112. The kiosk 1100 can additionally include a plurality of internal return bins 1124 and a recycling bin 1120. In the illustrated embodiment, the return bins 1124 are positioned inside the kiosk 1100. The return bins 1124 can be configured to hold products returned by purchasers via the access door 1106. In addition, if a seller wishes to remove an item from sale, the seller can remotely instruct the kiosk 1100 to remove the item from the corresponding display window 1112 and place the item in one of the return bins 1124 for holding until the seller retrieves the product from the kiosk 1100. The recycling bin 1120 can be positioned within the kiosk 1100 below the access door 1106 to allow consumers to recycle products by opening the access door 1106 and dropping or placing the recycled products into the appropriate bin. In other embodiments, the recycling bin 1120 can be positioned elsewhere within the kiosk 1100 or in an adjoining container. As described above with reference to FIG. 9, the kiosk 1100 can include a robotic arm or similar mechanism to move the various consumer products from place to place within the kiosk 1100.

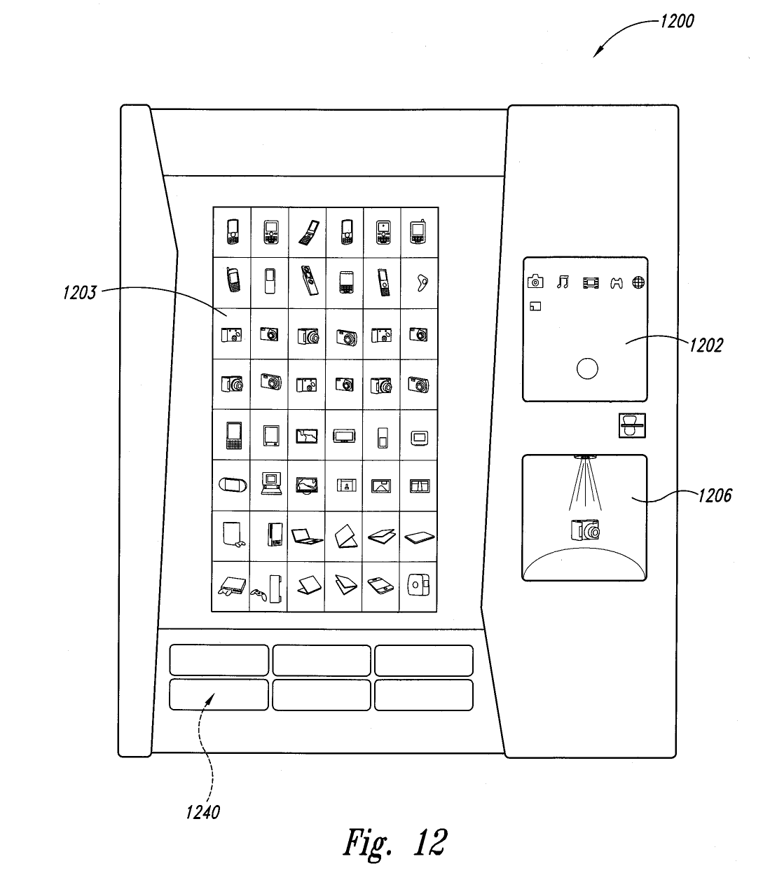

FIG. 12 is a front elevation view of a consumer-operated kiosk 1200 (“kiosk 1200”) configured in accordance with yet another embodiment of the disclosure. Various features of the kiosk 1200 are at least generally similar in structure and function to the corresponding features of the kiosks 100 and 1100 described above. In this particular embodiment, however, the kiosk 1200 does not display the actual products for sale, but instead displays digital pictures of the products on a display screen 1203 (e.g., a large touch screen monitor). The display screen 1203 enables users to manipulate the digital images of the products (e.g., enlarge the images, zoom in, zoom out, move the images around, rotate the images, select alternate views, etc.). To view the actual product, the user can select the product via the display screen 1203 and/or the user interface 1202, and the product can be delivered to an access door 1206 via, for example, a suitable robotic mechanism as described above with reference to FIG. 9. In the illustrated embodiment, the access door 1206 includes a glass window and internal lights that showcase the selected product for inspection by a potential buyer before purchase. If the user declines the purchase, the product is moved from the access door 1206 to a storage area 1204 behind the digital display 1203 in which the products for sale are held.

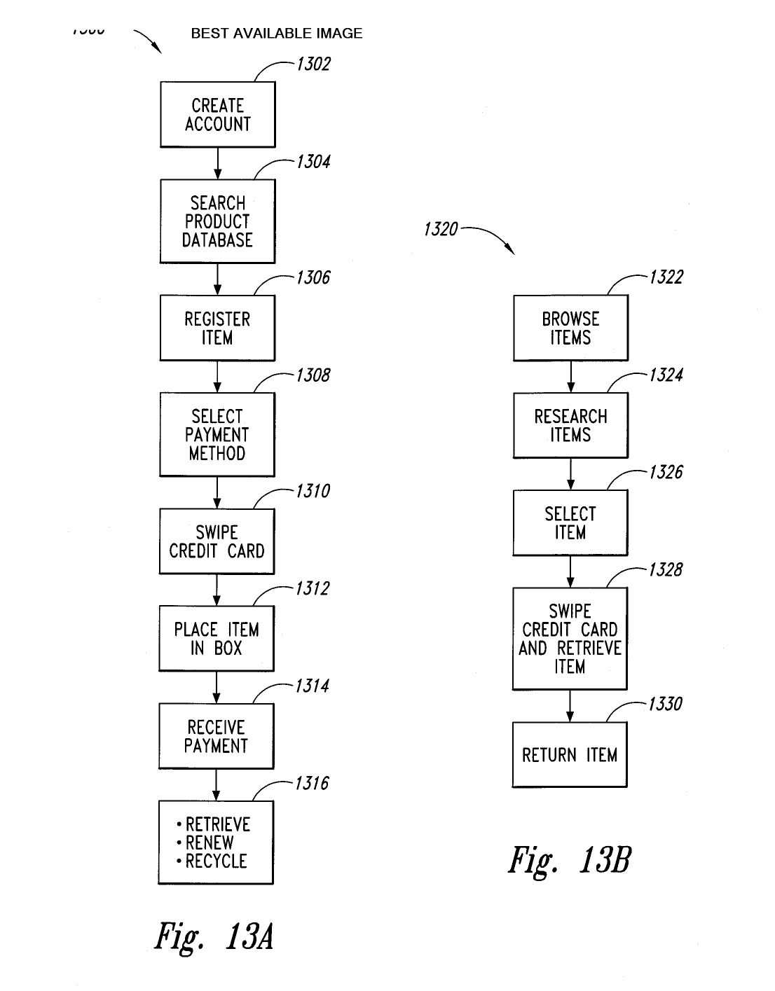

FIG. 1313A is a flow diagram of a routine 1300 for selling an item with one or more of the kiosk embodiments described above, and FIG. 13B is a flow diagram of a routine 1320 for purchasing an item from one or more of the kiosk embodiments described above. Many features of the routines 1300 and 1320 are at least generally similar to corresponding features of the selling and buying routines described above with reference to, for example, FIGS. 2A and 2B. At least a portion of the routines 1300 and 1320, however, can be performed via the kiosk or a remote website.

Turning first to FIG. 13A, when selling an item a user begins in block 1302 by creating an account. In one aspect of this embodiment, a confirmation (e.g., an e-mail or other electronic message confirmation) can be sent or otherwise provided to the user to confirm that the user has created an account. The confirmation can also provide the user with an account profile. In block 1304, the user can search a product database. The product search can include searching for particular product information, requesting a picture of a product, pricing benchmarks, etc. Both steps 1302 and 1304 of the routine 1300 can be performed in person via the kiosk or remotely via a website. In block 1306, the user registers the product by selecting a price and selecting product details (e.g., category, brand, model). In block 1308, the user selects a payment method by choosing from different payment options including, for example, PayPal™, credit, check, direct deposit, etc. Steps 1306 and 1308 can also be performed via the kiosk or via a remote user computer and a website.

To place an item in the kiosk for sale, the user begins in block 1310 and swipes a credit card for identification purposes. Once the credit card information has been verified, the routine 1300 moves to block 1312 where the access door is released and the user places the product in a display box. The user can receive an email or other electronic message as a receipt for the item. Once the product has been placed in the display box, a suitable system, such as a robotic mechanism, moves the product to a selected or pre-assigned display window. In other embodiments, a picture can be taken of the product and displayed on a display screen (e.g., the display screen 1203 described with reference to FIG. 12). The steps of swiping the credit card and placing the product in a display box can only be performed at the kiosk. During the time the product is on sale, the user can receive various updates via e-mail, Twitter, and/or other electronic message systems to apprise the user of sale status, product inquiries, etc. Once the product sells, the routine 1300 moves to block 1314 where the user receives payment. If the product does not sell, in block 1316, the user can return to the kiosk and retrieve the product, renew the sale offer, or elect to recycle the product.

Turning next to FIG. 13B, a potential buyer can proceed in block 1322 by browsing products for sale either at the kiosk or remotely via a website. In block 1324, the buyer can research an item by selecting the display window or “storefront” corresponding to the item and reading product information, either via the kiosk or remotely via a website. In block 1326, the buyer can select a product for purchase. As discussed above, the buyer can perform the steps of viewing, researching, and reserving products remotely via a user computer, handheld device, or other suitable Internet-enabled device before proceeding to the kiosk to pay for and retrieve a selected product. In the illustrated embodiment, in block 1328, the user pays for the item at the kiosk. In other embodiments, however, the buyer can elect to pay for the product remotely via a website. Payment can be in the form of a credit card that is swiped through a card reader on the kiosk and/or by entering credit card information into the website. Once the credit card information has been verified and the purchase authorized, the product can be moved from the display box (or a storage box in the case of a digital display kiosk) and delivered to the access door for retrieval by the buyer. Additionally, once the credit card purchase has been authorized, the seller can receive an electronic confirmation of the sale as described above. The buyer can receive a paper receipt or other electronic receipt identifying the purchase price, the item purchased, and/or other purchase information. If the buyer wishes to return the item within a preset period of time (e.g., five days), in block 1330, the buyer can return the item to the kiosk for a refund. Should this happen, the seller can receive an electronic message notifying the seller that the product was returned and explaining any steps necessary for refunding the funds to the buyer.

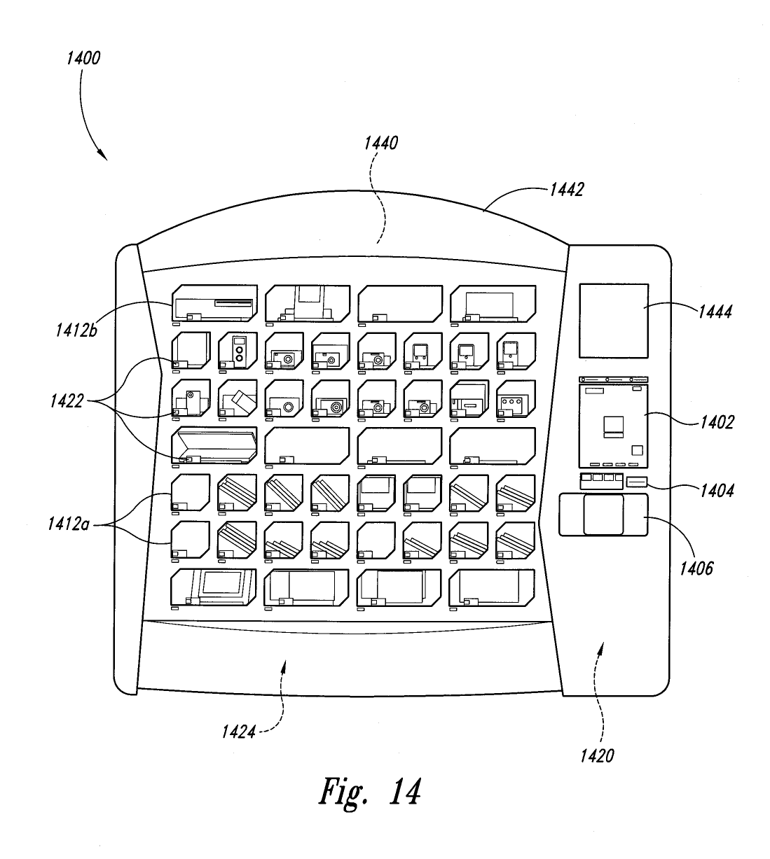

FIG. 14 is a front isometric view of a consumer-operated kiosk 1400 (“kiosk 1400”) configured in accordance with another embodiment of the disclosure. Many features and aspects of the kiosk 1400 are at least generally similar in structure and function to the kiosks described in detail above. For example, the kiosk 1400 includes a plurality of first display windows 1412a, a plurality of relatively larger, second display windows 1412b, a user interface 1402, a card reader 1404, and an access door 1406. In at least one embodiment, however, the kiosk 1400 can sell new, pre-owned, and/or refurbished consumer products, but does not allow individual users to sell their own products. The products can be part of an inventory 1440 that is locally stored within a housing 1442 of the kiosk 1400. As illustrated in FIG. 14, for example, each product in the inventory 1440 can be displayed in one of the display windows 1412 and removed after a buyer purchases the product. As discussed above, after the user purchases the product, a robotic arm or other suitable mechanism can grasp the selected product and transfer it to the access door 1406 for retrieval by the buyer. In some embodiments, the access door 1406 can be locked remotely (e.g., via the communications link 1010 of FIG. 10) to prevent users from accessing the products stored within.

In other embodiments, the display windows 1412 can display samples corresponding to the products in the inventory 1440, and can include one or more of the same product in the inventory 1440. The samples can be unwrapped from the packaging, and displayed with favorable lighting in each of the appropriately sized display window 1412. A buyer wishing to buy one of the products in the inventory 1440 can peruse the unwrapped samples in the display windows 1412, and select a corresponding product for purchase. In some embodiments, the sample of the selected product can be transferred from the display windows 1412 to the access door 1406 (e.g., via robotic mechanism) to allow the buyer to look at and/or touch the sample in more detail. If the buyer wishes to proceed with the purchase of the product, the kiosk 1400 (e.g., via a robotic mechanism) can remove the product in its packaged form from the inventory 1440 (e.g., behind the display windows 1412 and deliver it to the access door 1406 (e.g., via robotic mechanism). Accordingly, the kiosk 1400 can provide a fully-automated machine that allows users to view the product or a sample thereof. In further embodiments, pictures of the products in the inventory 1440, rather than the physical products, can be displayed on a display screen (e.g., the display screen 1203 shown in FIG. 12).

In various embodiments, the kiosk 1400 also includes a plurality of individual price displays (e.g., LED price displays) 1422 associated with the different products in each of the display windows 1412. The prices in the price displays 1422 can be updated when a new product is displayed, if the price of a product has been changed, and/or when the product has been sold out of the inventory 1440.

The kiosk 1400 can additionally include a plurality of internal return bins 1424 and a recycling bin 1420. In the illustrated embodiment, the return bins 1424 are positioned inside the kiosk 1400. The return bins 1424 can be configured to hold products returned by purchasers via the access door 1406. In various embodiments, for example, the return bins 1424 can be configured to be sized larger than the returned product since users typically have difficulty fitting the product and associated components into the original packaging. To return a product, the user can place the product in one of the return bins 1424 via the access door 1406. A serial number and/or other identification number can be entered (e.g., via the user interface 1402) or automatically scanned to verify that the product was previously sold by the kiosk 1400 (or another kiosk in the same network). Once verified, the user can receive a refund.

The kiosk 1400 can also include an internal recycling/trade-in bin 1420. The recycling bin/trade-in 1420 can be positioned within the kiosk 1400 below the access door 1406 to allow users to recycle products by opening the access door 1406 and dropping or placing the recycled products into the appropriate bin. In other embodiments, the recycling/trade-in bin 1420 can be positioned elsewhere within the kiosk 1100 or in an adjoining container.

In several embodiments, the user can receive a credit (e.g., voucher, gift card, gift card number, etc.) from the kiosk 1440 (e.g., via e-mail, receipt, bank account deposit, etc.) after trading in an unwanted electronic item in the recycling/trade-in bin 1420. The credit can be applied toward the purchase of another product in the inventory 1440 and/or purchases with other retailers or businesses. In some aspects, the amount of credit can relate to the value of the recycled product. The user, for example, can select a “trade-in” button via the user interface 102 and select the type of product he or she wishes to trade-in (e.g., a video game). The kiosk 1400 can then assign a value to the product and display the value via the user interface 1402 and/or other suitable display. If the user accepts the trade-in value offered, the user can select the terms of the sale and receive an associated credit. The credit can be given at the time of trade-in, or can be subsequently delivered after, for example, the quality of the product is determined.

As shown in FIG. 14, the kiosk 1400 can further include a digital display 1444 positioned above the user interface 1404 to provide advertisement and information related to the products in the inventory 1440. In other embodiments, the digital display 1444 can be positioned elsewhere within view of the user. The digital display 1444 can also be used by retailers, manufacturers, and/or other advertisers to display information.

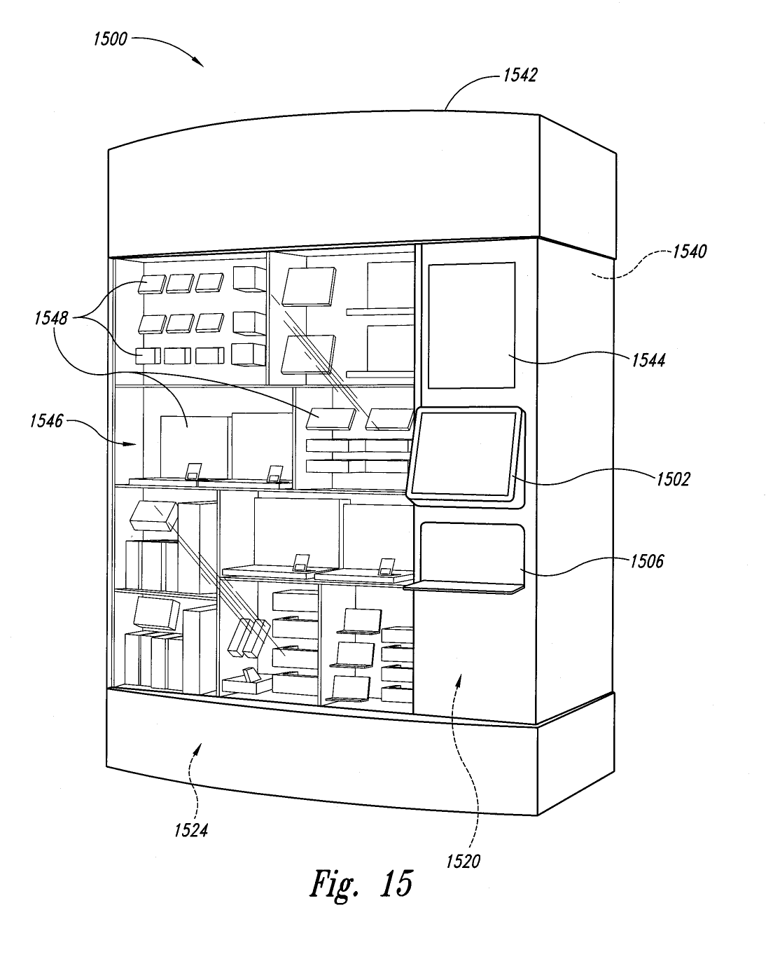

FIG. 15 is a side isometric view of a consumer-operated kiosk 1500 (“kiosk 1500”) configured in accordance with another embodiment of the disclosure. Many features and aspects of the kiosk 1500 are at least generally similar in structure and function to the kiosk 1400 shown in FIG. 14. For example, the kiosk 1500 includes a user interface 1502, an access door 1506, a digital display 1544, return bins 1524, and recycle/trade-in bins 1520. The kiosk 1500 also includes an inventory 1540 of new, pre-owned, and/or refurbished consumer products that are stored locally within a housing 1542 of the kiosk 1500. The kiosk 1500 further includes a display area 1546 that includes a plurality of display regions 1548. The display regions 1548 can have varying shapes and sizes, and can be configured to favorably display samples corresponding to products in the inventory 1540. As described above, the samples can be unpackaged versions of the products in the inventory 1540. The large display area 1546 can provide retailers with more flexibility to change the layout of the samples, enhance the display of various samples for user viewing, and generally increase the aesthetic appeal of the kiosk 1500.

In several embodiments, the kiosks 1400 and 1500 described above can be accessed remotely via a communications network (e.g., the communications network 1010 of FIG. 10). A user can view the products for sale in the inventory 1440, 1540 using a personal computer, smart phone, and/or other remote device. The user can select a product to purchase and can opt either to reserve the product until a specified time and/or pay for the product in advance (e.g., via the internet). Once reserved or purchased, the kiosk 1400, 1500 may remove one of the selected products (e.g., with a robotic mechanism) from the inventory 1440, 1540 to prevent other users from buying the last of the product. When the user wishes to retrieve the purchased product, the user can enter card information (e.g., credit card information) via the card reader 1404 and/or the user interface 1402 to identify himself or herself as the buyer. The kiosk 1400, 1500 can then request payment (if not already purchased), and retrieve the product from the inventory and tender it to the user via the access door 1406.

In various embodiments, two or more of the kiosks 1400 and 1500 can also be coupled together in a network of kiosks via the communications link. This can allow users to select a product and then determine in which kiosk 1400, 1500 within the network it is located. In one embodiment, for example, a user can view the inventories of all of the kiosks in the network and search based upon proximity and product type. If the user wishes to buy the product, the product can be reserved at the appropriate kiosk.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A method for purchasing consumer electronic products, the method comprising:
providing a consumer-operated kiosk having a card reading device, a user interface, and an inventory of consumer electronic products stored locally within the kiosk;
displaying the inventory;
displaying transaction options to the user, wherein at least one transaction option corresponds to purchasing one of the consumer electronic products in the inventory;
receiving a user selection corresponding to purchasing a first product, wherein the first product is one of the consumer electronic products in the inventory;
receiving payment information from the user via at least one of the card reading device and the user interface, wherein the card information is associated with the user; and
dispensing the first product via an access door.

2. The method of claim 1 wherein providing the consumer-operated kiosk includes providing a consumer-operated kiosk having an inventory comprising at least one of flash drives, laptop computers, gaming consoles, cameras, DVDs, mobile phones, and GPS systems.

3. The method of claim 1 wherein providing the consumer-operated kiosk includes providing a consumer-operated kiosk having an inventory comprising refurbished consumer electronic products.

4. The method of claim 1 wherein:
displaying the inventory includes displaying the first product in a first display window and displaying a refurbished consumer electronic product in a second display window; and
dispensing the first product includes retrieving the first product from the first display window and positioning the first product proximate the access door.

5. The method of claim 1 wherein displaying the plurality of consumer electronic products includes displaying a digital image of a sample product on at least one of the user interface and a display screen on the kiosk, wherein the sample product is at least substantially similar to the first product.

6. The method of claim 1 wherein displaying the inventory includes displaying a sample product in at least one of a display window and a display area, wherein the sample product is at least substantially similar to the first product.

7. The method of claim 1 wherein dispensing the first product includes retrieving the first product from the inventory, and positioning the first product proximate to the access door.

8. The method of claim 1 wherein:
displaying the inventory includes displaying the inventory on a remote computer;
receiving the user selection includes receiving the user selection corresponding to purchasing the first product via the remote computer; and
the method further comprises reserving the first product until the user retrieves the first product from the kiosk.

9. The method of claim 1, further comprising:
receiving a user input via the user interface, wherein the user input include trade-in a product;
receiving product information related to the trade-in product;
assigning a trade-in value to the trade-in product;
receiving the trade-in product in a trade-in bin via the access door; and
dispensing a credit equivalent to the trade-in value.

10. The method of claim 1, further comprising receiving a returned product in a return bin via the access door, wherein the returned product is a previously purchased consumer electronic product from the inventory.

11. The method of claim 1 wherein the kiosk is one of a plurality of consumer-operated kiosks connected together via a communications link, and wherein the method further comprises receiving a returned product to a recycle bin in any one of the plurality of consumer operated kiosks, and wherein the returned product being a previously purchased consumer electronic from the inventory.

12. A consumer-operated kiosk system for selling consumer electronic products, the consumer operated kiosk comprising:
a housing;
a card reading device configured to receive card information associated with a user;
an inventory of consumer electronic products stored within the housing;
a user interface configured to display transaction options to the user, wherein the transaction options include purchasing one of the consumer electronic products from the inventory;
a display configured to represent the consumer electronic products in the inventory to the user;
an access door; and
a grasping mechanism configured to move a selected consumer electronic product from the inventory to an access area proximate to the access door, wherein the access door is configured to open when the selected product is in the area.

13. The consumer-operated kiosk of claim 12 wherein the inventory comprises refurbished consumer electronic products.

14. The consumer-operated kiosk of claim 12 wherein the display comprises a plurality of display windows, wherein individual display windows are configured to display one consumer electronic product in the inventory, a first set of the display windows have a first size, a second set of the display windows having a second size larger than the first size, and the first set of display windows being configured to display smaller consumer electronic products than the second set.

15. The consumer-operated kiosk of claim 12 wherein the display comprises a display area configured to display sample products, wherein the sample products correspond to the consumer electronic products in the inventory.

16. The consumer-operated kiosk of claim 12 wherein the display comprises a display area configured to display at least one of sample products and the consumer electronic products in the inventory, wherein the sample products correspond to the consumer electronic products in the inventory, and wherein the display area includes a plurality of lighting features configured to individually illuminate the consumer-electronic products and the sample products.

17. The consumer-operated kiosk of claim 12 wherein the display comprises a display screen configured to show images of sample products, wherein the sample products correspond to the consumer electronic products in the inventory.

18. The consumer operated kiosk of claim 12, further comprising a return bin configured to receive consumer electronic products previously removed from the inventory.

19. The consumer operated kiosk of claim 12 wherein the consumer access door is configured to be locked in a closed position via a remote controller.

20. A consumer-operated kiosk system, comprising:
a communications link;
a plurality of consumer-operated kiosks coupled together via the communications link, wherein individual consumer-operated kiosks include an inventory having a plurality of consumer electronic products;
means for displaying the inventory;
means for displaying transaction options to the user, wherein at least one transaction option corresponds to purchasing one of the consumer electronic products in the inventory;
means for receiving a user selection corresponding to purchasing a first product, wherein the first product is one of the consumer electronic products in the inventory; and
means for dispensing the first product from an access door.

21. The consumer-operated kiosk system of claim 20 wherein the means for dispensing the first product includes means for moving the first product from the inventory to an access area proximate the access door.

22. The consumer-operated kiosk system of claim 20 wherein the means for displaying the plurality of consumer electronic products includes means for displaying digital images of the consumer electronic products in the inventory.

23. The consumer-operated kiosk system of claim 20 wherein:
the plurality of consumer-operated kiosks include a first kiosk and a second kiosk, wherein the first kiosk has a first inventory and the second kiosk has a second inventory different from the first inventory;
the means for displaying the inventory includes means for displaying digital images of the second inventory on the first kiosk; and
means for retaining a product in the second kiosk until retrieved by the user.
